(19) United States
(12) Patent Application Publication
(10) Pub. No.: US 2005/0010996 A1
(43) Pub. Date: Jan. 20, 2005

(54) Protective suit ventilated by self-powered bellows

(76) Inventor: Robert B. Steinert, North Branch, NJ (US)

Correspondence Address: ROBERT B. STEINERT, 32 VILLAGE WAY, NORTH BRANCH, NJ, 08876, US

(21) Appl. No.: 10/716,854

(22) Filed: Nov. 20, 2003

Related U.S. Application Data
(63) Continuation-in-part of application No. 10/621,565, filed on Jul. 17, 2003.

(51) Int. Cl. A62B 17/00; A62D 5/00

(52) U.S. Cl. 2/458

(57) ABSTRACT

Protective suits are used to protect the wearer against hazardous materials such as particulates, liquids, chemicals, pathogens, radiation, electromagnetism, physical trauma, heat and for rain protection. They are used to protect the wearer's surrounding in cleanrooms. Medical protective suits are used to prevent the spread of pathogens from the wearer. Unfortunately, they can cause heat stress by reducing air circulation. This invention discloses a protective suit with bellows and dual one-way valves operated by the normal movement of the wearer to draw air through the suit's interior to cool the wearer and provide breathable air. Filters can be placed in the bellows and suit's air vents, or the suit can be made of a filter material to protect the wearer and the surroundings. The disclosed suit is lighter, less expensive and more mobile than prior-art protective ventilated suits that use powered or externally supplied ventilation and cooling devices. It does not depend on limited life portable power sources for ventilation. Filtered air, supplied by the bellows, can be used for breathing, eliminating the need for a separate source of air.

### CROSS REFERENCE TO RELATED APPLICATION

“Ventilated Breathing Powered Protection Suit” specification submitted by Robert B. Steinert, Ser. No. 10/613,948, Filing Date Jul. 7, 2003, Customer Number 37498.

### FEDERALLY SPONSORED RESEARCH OR DEVELOPMENT

Not Applicable.

### SEQUENCE LISTING

Not Applicable.

### BACKGROUND OF THE INVENTION

Protective suits are in wide use. They are designed to protect the wearer from Hazardous Materials (pathogens, chemicals, particulates, and radioactive contaminates). They are used to protect clean environments from potentially harmful sources from the wearer, such as particular contaminations in cleanrooms. They are used to protect people and animals from pathogens spread by the wearer such as in the surgical operating rooms of medical facilities and for the protection of laboratory animals, which must be pathogen free. They are used to protect workers from electrical, electromagnetic and radioactive sources. They are used for protection from liquids such as chemicals or rain. They are used for physical trauma protection in applications such as construction work, high-speed motor sports and skiing. They are used for heat protection.

The impermeable or semi-permeable construction of these suits is known to limit or eliminate air circulation on the wearer's body, reducing the required body heat loss and evaporation rates. Exhaustion, discomfort and heat stress can result from wearing such suits. To reduce the heat and moisture buildup, the wearer may open the suit's closures to increase ventilation, circumventing the suit's protection.

To reduce these adverse effects, ventilated protection suits of various designs have been disclosed. They use: an external source of supplied air such as compressed air or compressed bottled air, a powered blower carried by the wearer to supply cooling and/or breathing air, or they supply coolants, either gases or liquids, that are contained in circulation devices in the suit's interior. The previously disclosed suits are expensive to produce, add physical weight to the wearer or function for limited periods. Attached supply lines limit the wearer's movement.

Unlike previous designs, this patent discloses the use of a protective suit fitted with a wearer-powered bellows with dual one-way valves which forces or draws air through the protective suit's interior. The air passing through the suit replaces the cooling and evaporation lost when a non-ventilated protective suit is worn. Filtering elements are placed in the air vents prevent harmful elements from entering or leaving the suit. The suit eliminates the need for the powered ventilation or external supplies of air or coolants required by the previously disclosed suits; increasing the wearer's mobility and eliminating the need for short lived portable power sources. It is less expensive to produce, lighter to wear, more comfortable and less restrictive of the wearer's movements than the previously disclosed ventilated or cooled suits. It eliminates the tendency to circumvent the protection of non-ventilated or non-cooled protective suits.

U.S. Pat. No. 3,710,395 (Jan. 16, 1973) and U.S. Pat. No. 5,960,475 (Oct. 5, 1999) disclose air permeable garments that provide for air circulation for cooling and evaporation. Their non-filtering construction renders them unsuitable for protective use.

U.S. Pat. No. 6,442,760 (Sep. 3, 2002) and U.S. Pat. No. 5,704,064 (Jan. 6, 1998) disclose ventilated suits that contain open vents in various locations in the suit to allow excess heat and moisture to escape. These openings prevent their use in most situations requiring protective suits. They do not have a mechanism to draw air through the suit. They provide minimal air circulation through the suit, limiting cooling and evaporation.

U.S. Pat. No. 5,564,124 (Oct. 15, 1996) and U.S. Pat. No. 4,903,694 (Feb. 27, 1990) disclose protective suits that use battery-powered blowers to ventilate the suit's interior. Such devices are expensive to produce, heavy and have a limited battery life.

U.S. Pat. No. 4,831,644 (May 23, 1989) discloses a ventilated protective hood attached to a protective suit that uses one-way valves to ventilate the hood and prevent condensation of the hood's window. It does not provide for ventilation of the protective suit.

U.S. Pat. No. 2,255,751 (Sep. 16, 1941), U.S. Pat. No. 2,573,414 (October, 30, 1951), U.S. Pat. No. 2,657,396 (Mar. 9, 1951), U.S. Pat. No. 3,292,179 (Dec. 29, 1966), U.S. Pat. No. 4,146,933 (Apr. 3, 1979), U.S. Pat. No. 4,172,454 (Oct. 30, 1979), U.S. Pat. No. 4,194,247 (Mar. 25, 1980), U.S. Pat. No. 4,286,439 (Sep. 1, 1981), U.S. Pat. No. 4,881,539 (Nov. 21, 1989), U.S. Pat. No. 4,458,680 (Jul. 10, 1984), U.S. Pat. No. 5,027,807 (Jul. 2, 1991), U.S. Pat. No. 5,355,857 (Oct. 18, 1994), U.S. Pat. No. 5,339,806 (Aug. 23, 1994) and U.S. Pat. No. 6,209,144 (Apr. 3, 2001) describe protective suits that use external sources for cooling and moisture evaporation, either stationary or carried by the wearer. Typical coolants are compressed bottled air or supplied air, which may also be used for breathing, or refrigerating fluids or gases circulated through the suit. These inventions require the use of a bulky heavy cooling device, carried by the individual, or the use of an external supply line that limits the mobility of the wearer. Their ventilation and cooling sources are expensive to produce. The present invention uses a lightweight bellows with one-way valves and the wearer's normal movement to draw filtered ambient air through the suit to cool the wearer. It does not require an external source of: power, refrigerants for cooling, or air for breathing, cooling and moisture removal.

### SUMMARY OF INVENTION

This invention discloses a ventilated protective suit through which fresh air is drawn, or blown, by at least one bellows powered by the movement of the wearer. The bellows can supply filtered air for both cooling and breathing when it is worn with a face mask that draws air from the suit's interior and exhausts it to the suit's exterior. The bellows have dual one-way valves. In one design option the first one-way valve allows air to be blown from the bellows, to the suit's interior, when the wearer's movement compresses the bellows, the second valve allows filtered air to be drawn into the bellows from the ambient when the wearer's movement expands the bellows. The opposite flow is also possible, that is, the first valve draws filtered air from the suit into the bellows when the bellows expands and the second valve discharges air to the ambient when the bellows is collapsed. Vents can be situated in the suit to allow air to enter, or leave, the suit's interior depending on the arrangement of the one-way valves. The vents can be filtered to prevent harmful elements from passing into or out of the suit. The vents are preferably placed near the body's extremities such as the hands, feet and head to expose the maximum area of the body to the fresh air circulation.

The suit can be constructed of materials designed to protect the wearer from hazards such as particulates, pathogens, chemicals, radiation, electricity, electromagnetism, heat, liquids or physical trauma or to protect the surroundings from hazards such as particulates and pathogens.

The bellows can be placed in any position in the suit that allows innate body movements to compress and expand the bellows. A position in the crook of the arm, opposite the elbow between the upper arm and the forearm, is preferable in most circumstances; folding and extension of the forearm is the most likely body movement, providing constant ventilation during for normal work. The bellows can also be placed behind the knee, in the crotch of the upper legs or the stomach area or in any other position that produces innate body movement.

The bellows can also be placed in any location in which it can be operated by the wearer, such as on the back or chest area.

The bellows can be designed to self-expand or self-collapse, reducing to one the number of strokes to operate the bellows. The self-expansion/collapsing motion of the bellows can be designed to occur slowly, reducing the peak airflow rates through the filters and suit, the pressure drop through the filters and the work required to operate the bellows.

A separate air accumulator can be used to reduce the peak airflow rates and filter pressure drop.

The bellows can be removable to eliminate it use in comfortable working temperatures when it is not required.

Particulate filters or chemical absorption elements can be placed in the suit's air vents to protect the wearer from potentially harmful agents such as dust, biological pathogens, radioactive materials or chemicals. They also prevent harmful elements from leaving the suit. Particulate filters or chemical absorption elements can be placed in the inlet or outlet ports of inlet or outlet one-way valves to prevent the passage of potentially harmful agents to the wearer or the surroundings and to prevent failure of the valves by an accumulation of contaminants in the valves.

The suit's body can be constructed of permeable or semi-permeable materials, allowing passage of at least some of the incoming fresh air to pass through the suit's body. In this design, the inlet air vents can be reduced in area or eliminated. The permeable or semi-permeable materials can be materials capable of protecting the wearer from hazards such as particulates, pathogens, chemicals, radiation, electricity, electromagnetism, heat, liquids or physical trauma and to protect the surrounding area from hazards such as particulates and pathogens. The outward passage of filtered air through the suit's fabric would reduce the rate that chemicals are adsorbed by the fabric, extending the useful adsorption life of the fabric.

The placement of the filtering elements on the suit reduces stress on the wearer's face and neck as well as reducing visual impairment. Removing the filter from the facemask reduces the work required for breathing. It also allows larger filtering area to be used, reducing the filters pressure drop and increasing its effective life.

The bellows-ventilating unit could be adapted to existing protective suits.

The bellows can be movable. For example, the bellows can be wom on the back when a separate breathing source is not required and moved to the chest when an SCBA is required.

The protective suit can be constructed without filtering elements for applications not requiring filtration, for protection from such sources as: radiation, electricity, electromagnetism, heat, liquids or physical trauma.

Face shields and eye shields, with viewing windows, can be incorporated into the vented suit. The shields can have air vents to allow air to pass through the shield(s) to prevent condensation from fogging the window(s). Particulate filter or chemical absorption elements can be placed in the shield(s) vents.

The suit in can be used with any of the well-known protective breathing masks such as those with filter elements for breathing ambient air or those supplied with an external source of air such as compressed bottled air or an air supply line.

The suit can be used with a breathing mask that draws air through the protective suit's body such as described in the co-pending patent specification “Ventilated, Breathing-Powered Protection Suit” submitted by Robert B. Steinert, Customer Number 37498. When used with this facemask, ventilating air can be drawn through the suit using the breathing power of the wearer alone when it is not practical or necessary to use the bellows ventilation. The facemask can be used to ventilate the suit without the bellows installed.

The disclosed ventilated suit protects the wearer, or adjacent areas. The suit relieves the discomfort, exhaustion and heat stress associated with non-vented non-air-conditioned protective suits. The suit does not require power, coolant or external air. The suit's design provides for a less expensive, lighter weight, more mobile protective suit than the previously known ventilated or cooled suits. It eliminates the tendency to bypass a non-ventilated suit's protective properties by opening the suit's closures.

### DESCRIPTION OF SEVERAL VIEWS OF THE INVENTION

The drawing illustrates a preferred embodiment of the suit that is the object of the present invention.

### DETAILED DESCRIPTION OF THE INVENTION

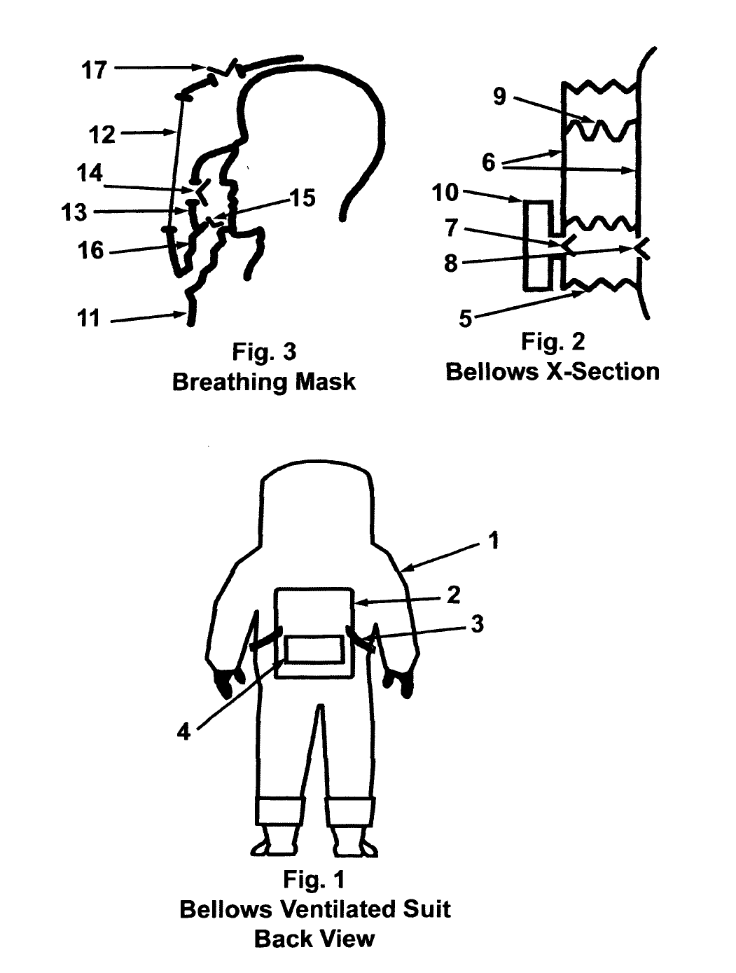

FIG. 1 is a rear view of the suit with the bellows attached to it's back. Item (1) is a protective suit. Item (2) is a bellows attached to the back of the suit. Items (3) are straps, attached to the bellows, which extend around the front of the suit. When the straps are pulled forward by the wearer, from the front of the suit, the bellows collapse, forcing air into the suit. When the straps are released, the bellows self-expands, drawing filtered air into the bellows. Item (4) is an air filter, attached to the bellows, which filters air entering the bellows.

FIG. 2 is a cross-sectional view of the Bellows. Item (5) is a flexible material forming the collapsible sides of the bellows. Items (6) are plates forming the front and back bases of the bellows. Item (7) is a one-way valve (also known as a check valve or automatic valve) which allows air to be drawn into the bellows when the bellows expands. Item (8) is a one-way valve which allows air to be forced into the suit's interior when the bellows is collapsed by pulling on the straps (not shown in this view). Items (9) are extension springs that self-expand the bellows when the straps are released. The springs are sized to slowly expand the bellows to minimize the peak airflow rate of air drawn through the filters. Item (10) is an air-purifying filter that removes harmful elements from the air that is drawn into the bellows and forced into the suit.

FIG. 3 is a cross-sectional view through the head and face shield of the suit and Breathing Mask. Item (11) is the protective suit. Item (12) is a sight window in the face shield in the suit. Item (13) is the breathing mask, worn over the wearer's nose and mouth. Item (14) is a one-way valve in the breathing mask which allows pre-filtered air to be drawn into the mask, from the suit's interior, when the wearer inhales. Item (15) is a one-way valve that allows exhaled air to discharge into an exhaust tube when the wearer exhales. Item (16) is a flexible exhaust connection that directs exhaled air to the suits exterior. When it is not practical or necessary to operate the bellows, filtered cooling/breathing air can be drawn through the suit and mask using the breathing power of the wearer alone. Item (17) is an air vent valve in the suit that allows filtered air, forced into the suit by the bellows, in excess of that breathed by the wearer, to escape through the suit's exterior. Vents can be placed near the body's extremities such as the hands, feet and head to allow the maximum exposure of the body to the ventilating air. They can be varied in area to provide for controlled ventilation through various sections of the suit. These vents can be equipped with particulate filters or chemical absorption elements to prevent ingress or egress of harmful materials.

1) A ventilated wearer-powered protective suit consisting of:
a. a body constructed of an impermeable, semi-permeable or permeable material capable of protecting the wearer from hazards such as particulates, pathogens, chemicals, radiation, electricity, electromagnetism, heat, liquids or physical trauma or is capable of protecting the surrounding area from hazards such as particulates and pathogens,
b. at least one bellows operated by the movement of the wearer to ventilate the suit's interior, with at least one pair of one-way valves to direct the flow of air.
c. air vents in the suit's body, to allow ventilating air to pass between the suit's interior and exterior.

2) A bellows described in claim (1) that has:
a. at least one one-way valve, of any of the well-known designs such as a flap valve or ball valve, spring assisted, gravity assisted or mechanically assisted, in the bellows, connected to the suit's body, constructed to allow ambient air to be forced from the bellows through the suit's interior and,
b. at least one one-way valve, of any of the well-known designs such as a flap valve or ball valve, spring assisted, gravity assisted or mechanically assisted, in the bellows, constructed to allow ambient air to be drawn into the bellows from the ambient.

3) A bellows described in claim (1) that has:
a. at least one one-way valve, of any of the well-known designs such as a flap valve or ball valve, spring assisted, gravity assisted or mechanically assisted, in the bellows, connected to the suit's body, constructed to allow ambient air to be drawn from the suit's interior into the bellows and,
b. at least one one-way valve, of any of the well-known designs such as a flap valve or ball valve, spring assisted, gravity assisted or mechanically assisted, in the bellows, designed to allow air forced from the bellows to be expelled to the ambient.

4) One-way valves described in claim (1) with permanently attached filtering and/or chemical absorbing elements in the valve ports to prevent harmful elements from passing through the valves to the suit's interior or to prevent foreign materials from causing valve failure,

5) One-way valves described in claim (1) constructed without filtering elements in the valve ports, for use in situations not requiring filtration, such as for protection from: radiation, electricity, electromagnetism, heat, liquids or physical trauma.

6) One-way valves described in claim (1) that contains replaceable particulate filtration and/or chemical absorption elements in the valve ports to prevent harmful elements from passing through the valves to the suit's interior or to prevent foreign materials from causing valve failure.

7) A protective suit described in claim (1) which has remotely mounted filtering elements, attached to the valves, with a flexible hose or any other well-known connection device.

8) A protective suit described in claim (1) that protects any part of the body such as, but not limited to: a suit that fully covers the body or a suit that partially covers the body, such as with uncovered hands, feet or head, or an upper body covering only, a head covering only or a lower body covering only.

9) A protective suit described in claim (1) with a partial face shield or eye shield, a full face shield, or hood covering the head of the wearer, that has:
a. at least one air outlet port connected to the suit's interior by an extension of the suit's body, or any other well-known connection technique between the shield and the suit's interior such as a flexible tube, to allow air to pass through the shield and the suit's interior,
b. a sight window.

10) A protective suit in claim (1) in which the air vents are placed in areas of the suit which maximize the passage of air past the wearer's body such as near the: head, hands and feet.

11) A protective suit described in claim (1) constructed, at least partially, of a permeable or semi-permeable material that is capable of passing a sufficient a quantity of air through the suit's body to reduce the vent area required in the suit or eliminate the use of air vents in the suit. The permeable material may contain chemically adsorbing materials to minimize the passage of harmful elements through the suit.

12) A protective suit described in claim (1) in which the base of the bellows forms part of the protective suit's body.

13) A protective suit described in claim (1) in which the bellows is constructed separately from the suit's body, with one of the one-way valves connected to the suit's interior by any well-known technique such as an extension of the suit's material or a flexible tube.

14) A protective suit described in claim (1) in which the suit has loose fitting flexible material in the areas between the bellows and the body extremities, such as between an elbow fitted bellows and the wrists, to allow the extremities to move without affecting the bellows position.

15) A suit described in claim (1) that has connections for the bellows that are closable or seal-able to allow removal of the bellows when it is not required while preventing ingress of harmful materials through the bellows connection ports.

16) A bellows described in claim (1) that is designed to be movable to different areas of the body.

17) A suit described in claim (1) that has more that one connection for the bellows, allowing the bellows to be moved to different areas of the body.

18) A bellows described in claim (1) that is operated by the wearer's movement both collapsing and expanding the bellows.

19) A bellows described in claim (1) which can be compressed by the wearer to expel the air and which self-expands to draw air in. The self-expansion can be performed by any of the well-known design techniques such as by incorporating compression springs or by constructing the bellows of a material that naturally regains it's original shape.

20) A self-expanding bellows described in claim (19) that is designed to slowly self-expand to reduce the peak air flow rates through the filters or suit.

21) A bellows described in claim (1) that can be expanded by the wearer to expel air and self-collapses to expel the air. The self-collapsing can be performed by any of the well-known design techniques such as by incorporating tension springs or by constructing the bellows of a material that naturally regains it's original shape.

22) A self-collapsing bellows described in claim (21) that is designed to slowly self-collapse to reduce the peak air flow rate through the filter or suit.

23) A bellows described in claim (2) which draws air atmospheric air through a filter and a separate air accumulator, situated between the filter and bellows, to reduce the filter's peak air flow rate and pressure drop.

24) A bellows described in claim (3) which draws air through filtered air vents on the suit, through the suit, and through a separate air accumulator, situated between the filtered air vents and bellows, to reduce the filter's and suit's peak airflow rates and pressure drop.

25) A ventilated protective suit described in claim (1) in which said bellows are placed in any position on the wearer's body in which innate movement of the wearer's body can expand and collapse the bellows, such as: the crotch of the elbow, the crotch of the knees, the buttocks, the crotch of the upper legs or in front of the hips.

26) A ventilated protective suit described in claim (1) in which said bellows are placed in any position on the wearer's body that allows the wearer to operate the bellows such as a chest mounted bellows that can be collapsed by movement of the wearer's hands/arms or a back mounted bellows that can be compressed by pulling on chest mounted straps attached to the bellows.

27) A protective suit described in claim (1) in which the bellows are of any of the well-known designs such as: a fan shaped bellows in which the corrugations meet at an apex, an longitudinally expandable corrugated tube, a rectangular bellows such as used in an accordion or any expandable and collapsible enclosed shape such as an elastic flexible tube that self expands when forces are removed from it, a blatter or a sphere.

28) A protective suit described in claim (1) in which the bellows has a base plate to hold the bellows in place when the wearer moves, with a base plate formed to fit the shape of the wearer's body part supporting the bellows.

29) A protective suit described in claim (1) in which the bellows are held in place by straps, of any of the well-known designs such as self-adjusting elastic straps or adjustable length straps, built into the suit's material or separate from the suit's material.

30) A protective suit described in claim (1) in which the bellows is held above the wearers body, to allow air to pass under and around the bellow's base, using any of the well-known techniques such as a three dimensional mesh, a double layered base or vent lines connected to open areas of the suit.

31) A protective suit described in claim (1) in which a blatter, or blatters, with one-way valves, is placed between the upper legs to allow the blatter(s) to expand and collapse when the wearer walks.

32) A protective suit described in claim (1) which has pockets located over the body joints, such as the elbow, opposite the bellows to orient the bellows when the joint is folded.

33) A pocket in claim (30) made solely from the suit's material, or with addition reinforcement material in the pocket, that is either an integral part of the suit's body or separate from the suit's body, attached to the bellows by any of the well-known techniques such as with the use of straps or the suit's material.

34) A protective suit described in claim (3) that is constructed to allow the passage of air through the suit when it collapses under the negative pressure created when air is drawn through the suit, using any well-known technique such as: stays, reinforcing loops, convolutions, three dimensional lining, such as mesh, batting, netting or tubes that allows air to pass through the suit's interior.

35) A protective suit described in claim (1) which has more than one one-way valve element in the one-way valves, connected in series, to allow for continued operation of the valves if one of the valve elements fails open (fails to close off the reverse flow of air).

36) Bellows described in claim (1) with more than one pair of one-way valves.

37) A suit described in claim (1) with more than one bellows, such as a pair of bellows, one in each arm joint.

38) A protective suit described in claim (1), in which the vents that allow air to pass through the interior of the suit, are areas that are commonly designed to be open, such as: the end of the legs and arms, the waist of a jacket, under arm vents, back vents and closures such as zippers and buttons.

39) A suit in claim (1) constructed without filtering elements in the air vents, for use in situations not requiring air filtration such as for protection from: radiation, electricity, electromagnetism, heat, liquids or physical trauma.

40) A protective suit described in claim (1) that contains replaceable filtration and/or chemical absorption elements in the air vents.

41) A protective suit described in claim (1) that with permanently attached filtering and/or chemical absorbing elements in the air vents which allow ambient air to pass through the suit's interior.

42) A protective suit described in claim (1) that with replaceable filtering and/or chemical absorbing elements in the air vents which allow ambient air to pass through the suit's interior.

43) Air vents in the suit's body described in claim (1) that are closable or seal-able enabling the vents to be closed when they are not required.

44) A protective suit described in claim (1) in which the air vents are shielded to prevent entry of liquids such as rain or chemicals.

45) A protective described suit in claim (1) that uses any of the well-known sources of breathable air such as: a protective breathing mask with permanent or replaceable filtering elements, a protective breathing mask with an external source of air such as compressed bottled air or air supplied by an attached line.

46) A protective described suit in claim (1) that uses a breathing mask with dual one-way valves that draws air from, or forces air through, the protective suit such as that described in the co-pending patent specification submitted by Robert B. Steinert, Customer Number 37498.
